(19) United States
(12) Patent Application Publication
(10) Pub. No.: US 2026/0077963 A1
(43) Pub. Date: Mar. 19, 2026

(54) Method for Operating a Robot Arm Using a Zoning Model

(71) Applicant: ABB Schweiz AG, Baden (CH)

(72) Inventors: Bart Vanderpijpen, Ninove (BE); Mikael Alhadeff, Braine l'Alleud (BE); Willem Vanderhoydonk, Halle (BE)

(73) Assignee: ABB Schweiz AG, Baden (CH)

(21) Appl. No.: 19/395,092

(22) Filed: Nov. 20, 2025

Related U.S. Application Data
(63) Continuation of application No. PCT/EP2023/064261, filed on May 26, 2023.

(51) Int. Cl. B65G 47/91

(52) U.S. Cl. CPC B65G 47/917

(57) ABSTRACT

A method for operating a robot arm for an automation system includes mounting a gripper having a plurality of suction elements arrangeable in an array for gripping an object; providing a control module comprising a matrix for mapping the array of the plurality of suction elements arranged at the gripper, and a zoning model; dividing, using the matrix and the array of the plurality of suctions elements into a plurality of zones; determining a group of zones to be activated out of the plurality of zones for gripping the object using the zoning model of the control module; and activating a group of suction elements out of the plurality of suction elements, which are arranged in the group of zones to be activated, to grip the object using an actuating unit.

### CROSS-REFERENCE TO RELATED APPLICATIONS

The instant application claims priority to International Patent Application No. PCT/EP2023/064261, filed May 26, 2023, which is incorporated herein in its entirety by reference.

### FIELD OF THE DISCLOSURE

The present disclosure generally relates to industrial automation and, more particularly, to a method for operating a robot arm for an automation system.

### BACKGROUND OF THE INVENTION

Industrial automation systems may provide productive and cost-efficient solutions for various applications for modern continuous, batch and discrete processes. Among them, robotic assemblies are widely implemented in assembly lines, for example, when being equipped with various robotic grippers such as vacuum grippers, pneumatic grippers, hydraulic grippers and servo-electric grippers. Conventionally, in order to drive such a robotic assembly for a specific purpose, a custom code needs to be written for an individual robotic gripper, so that the robotic gripper may be programmed within the respective robot assembly itself. Therefore, a generic control system for the robotic assembly is highly desired with improved flexibility and efficiency.

### BRIEF SUMMARY OF THE INVENTION

The disclosure generally describes an improved method for controlling a robotic assembly with a higher flexibility and automation efficiency. According to a first aspect of the disclosure, a method for operating a robot arm for an automation system is provided. The method comprises: mounting a gripper, at which a plurality of suction elements are arrangeable in an array, for gripping an object; providing a control module comprising a matrix for mapping the array of the plurality of suction elements being arranged at the gripper and a zoning model; dividing, using a zoning model, the matrix and the array of the plurality of suctions elements into a plurality of zones; determining a group of zones to be activated out of the plurality of zones for gripping the object by means of the zoning model of the control module; and activating a group of suction elements out of the plurality of suction elements, which are arranged in the group of zones to be activated, to grip the object by means of an actuating unit.

### BRIEF DESCRIPTION OF THE SEVERAL VIEWS OF THE DRAWINGS

FIG. 1 is an outline view of a robot arm disposed in an operating environment in accordance with the disclosure.

FIG. 2a is a diagram of a robot arm comprising a control module according to the present disclosure.

FIG. 2b is an additional diagram of a robot arm comprising a control module according to the present disclosure.

FIG. 2c is a diagram of a robot arm comprising a control module according to the present disclosure.

FIG. 3a is a diagram of another example of a robot arm comprising a control module according to the present disclosure.

FIG. 3b is a diagram of another example of a robot arm comprising a control module according to the present disclosure.

FIG. 3c is a diagram of another example of a robot arm comprising a control module according to the present disclosure.

FIG. 4 is a flowchart for a method for operating a robot arm for an automation system according to the present disclosure.

### DETAILED DESCRIPTION OF THE INVENTION

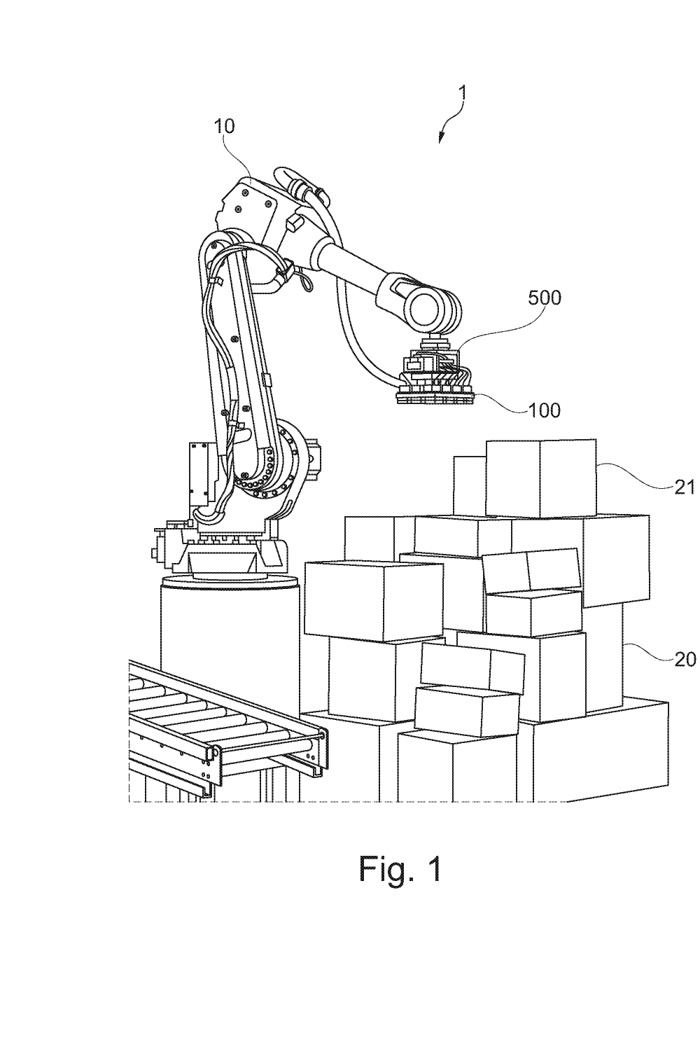

FIG. 1 shows schematically an example of a robot arm 10 for an automation system 1, which may be provided in a palletizing or depalletizing station. The robot arm 10 comprises a gripper 100, which is mounted or attached to the robot arm, in particular the movable, freestanding end of the robot arm 100 to grip an object 21 being arranged in a palletizing cell 20.

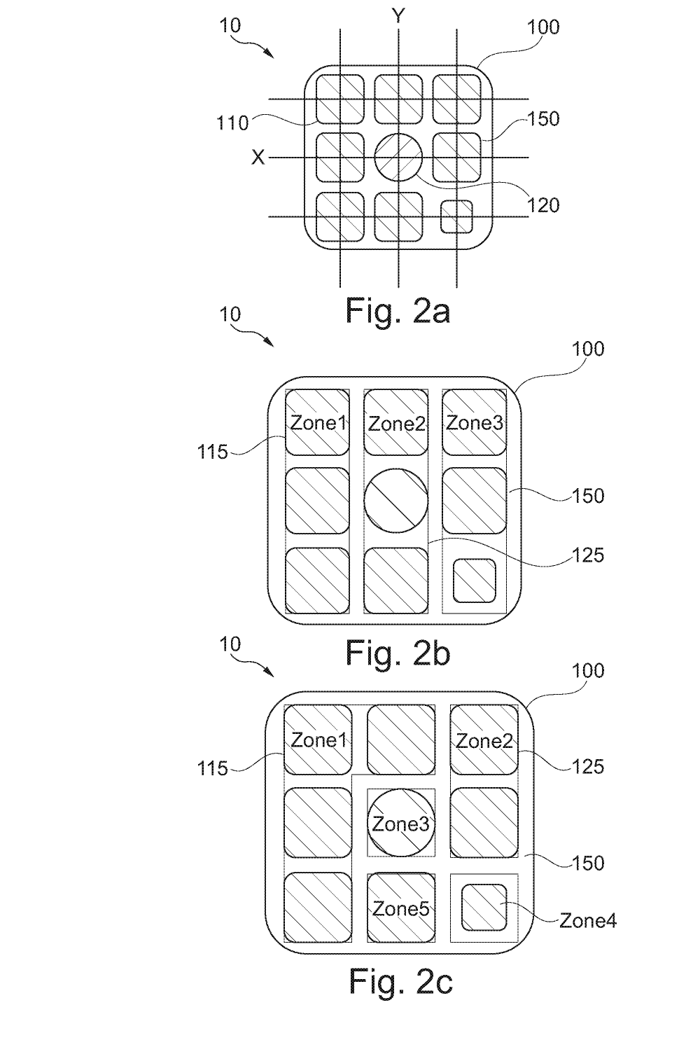

The gripper 100 of the robot arm 10 in FIG. 1 may comprise a plurality of suction elements 110, as shown in FIGS. 2a to 2c, which may be arranged in an array 150 at the gripper 100. The gripper 100 may be a vacuum gripper. For example, in case that the gripper 100 may be designed to be plate-shaped and comprise a gripper surface, the plurality of suctions elements 110 may be arranged in the array on the gripper surface.

The robot arm 10 may further comprise a control module (no shown), which my comprise a matrix that may be configured to map the array of the plurality of suction elements 110, 120 being arranged at the gripper 100. The control module may be arranged in the robot arm 100. Alternatively, or additionally, the control module may be designed as a computer program and arranged in a mobile terminal, such as in a laptop or a smartphone, a server or a cloud system of the automation system 1, which may comprise a plurality of robot arms including the robot arm 10. The control module may thus be remote or distant from the gripper 100 and communicate with the gripper via a cable or wirelessly, e.g. via radio.

Each of the plurality of suction elements 110, 120 may be designed to be a suction cup. For example, the suction cup may be a round suction cup, an oval suction cup or a rectangular suction cup or in any further shape. Also, the suction cup may be a flat suction cup or a bellow suction cup. It may be provided, the plurality of suction elements 110, 120 comprise various sizes and shapes representing various types of the suction elements 110, 120.

For example, the plurality of suction elements may comprise a first suction element 110 and a second suction element 120. In FIG. 2a, as the first suction element 110 is arranged in a different row along a y-axis and/or a different column along an x-axis of the array 150 and in the matrix than the second suction element 120, the first suction element 110 comprises a different x-coordinate and/or y-coordinate in the array 150 and in the matrix than the second suction element 120. The first suction element 110 may comprise a square shape, while the second suction element 120 may comprise a circle shape.

The control module for the gripper 100 may further comprise a zoning model. In particular, the zoning model or the zoning logic of the control module may comprise and follow a model agnostic approach.

The control module may be configured to divide, by means of the zoning model, the matrix and the array 150 of the plurality of suction elements 110, 120 into a plurality of zones 115, 125. The dividing or zoning the plurality of suction elements may be performed, by means of the zoning model of the control module, based on at least one characteristic of the object 21 to be gripped. The at least one characteristic of the object 21 may be a size, a shape, a center of gravity, a type of material and/or a way of packaging of the object. Hence, the robot arm 10 may further comprise an object detecting unit, which may be configured to detect the object 21 for analyzing the at least one characteristic of the object 21. Alternatively, or additionally, the dividing or zoning the plurality of suction elements may be performed, by means of the zoning model of the control module, based on the size and the shape of each of the plurality of suction elements being arranged in the array 150 at the gripper and in the matrix of the control module.

For example, the plurality of zones may comprise a first zone 115, in which the first suction element 110 may be arranged, and a second zone 125, in which the second suction element 120 may be arranged.

Each of the plurality of zones 115, 225 may be defined to comprise an individual shape or form. The plurality of zones may have the same shape or, respectively, a different shape. For example, in FIG. 2b, both the first zone 115 and the second zone 125 are divided or zoned into the same line-shape covering, respectively, three suction elements that are arranged adjacent to one another. In contrast, in FIG. 2c, the first zone 115 is divided into a L-shape covering four suction elements, while the second zone 125 is divided into a short L-shape covering, for example, only two adjacent suction elements. Further, the plurality of zones may, respectively, be square-shaped covering one or more suction elements, circle-shaped or U-shaped.

Moreover, the control module may be configured to determine a group of zones to be activated out of the plurality of zones 115, 125 for gripping the object. The group of zones to be activated may comprise one or more zones of the plurality of zones. In order to grip the object 21, the determining the group of zones to be activated may be performed, by means of the zoning model of the control module, based on the at least one characteristic of the object 21 and/or the size or the shape of each of the plurality of suction elements 110, 120 being arranged in the array 150. For example, the group of zones to be activated may comprise the first zone 115 and/or the second zone 125.

FIG. 2b shows that the control module may be configured to redivide, by means of the zoning model, the matrix and the array 150 of the plurality of suction elements 110, 120 into a second plurality of zones for gripping a second object, when the second object to be gripped may be detected by means of the object detecting unit. The second object may comprise at least one different characteristic, such as a different size, a different shape, a different gripping area or a different center of gravity. Accordingly, the control module may be configured to determine a second group of zones to be activated out of the second plurality of zones 115, 125 in the same matrix and the same array 150 for gripping the second object. Also, the actuating unit 500 may be configured to activate the second group of suction elements out of the plurality of suction elements 110, 120, which may be arranged in the group of zones to be activated in the array 150, to grip the second object. In this way, the same gripper 100 and the same array 150 of the plurality of suction elements 110, 120 may be used for gripping different objects, such as the object 21 and the second object, without switching or detaching the gripper 100. The control module having the zoning model may be designed to be a general, common or universal interface for the robot arm that is configured to grip various objects using a common gripper.

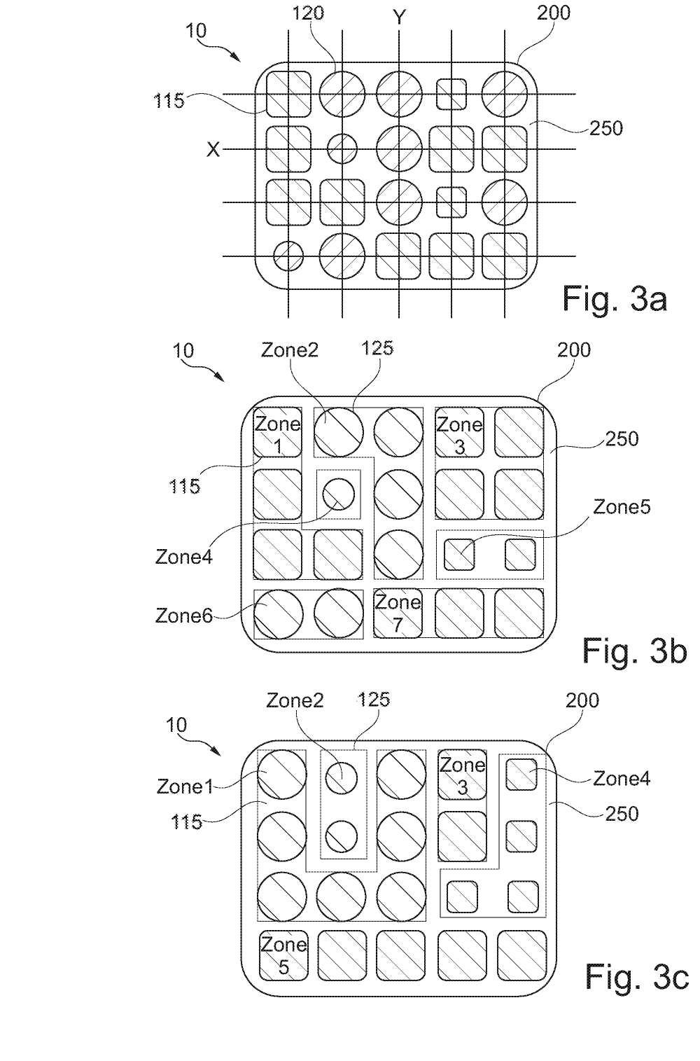

Alternatively or additionally, FIGS. 3a to 3c show, respectively, that the robot arm 10 may further comprise a plurality of grippers, in particular, a second gripper 200. It may be provided that the plurality of suction elements 110 and 120 may be arranged in a second array 250, which may comprise a larger area, at the second gripper 200. The second gripper 200 may be configured to replace the gripper 100, for example by detaching the gripper 100 and mounting the second gripper 100 to the robot arm 10.

FIG. 3a shows that the second gripper 200 may comprise a larger gripper surface than the gripper 100, and that more suction elements 110, 120 may be arranged in the second array 250 than in the array 150.

To grip the second object using the second gripper 200, the matrix of the control module may be adapted to map the second array 250 of the plurality of suction elements 110, 120 being arranged at the second gripper 200. Accordingly, the zoning model of the control module may also to adapted for gripping the second object. In particular, by means of the adapted zoning model, the control module may be configured to divide the adapted matrix and the second array 250 of the plurality of suction elements 110, 120 into a plurality of zones comprising, for example, a first zone 115 and a second zone 125.

In FIG. 3b, the plurality of zones may, respectively, be L-shaped covering a plurality of square and/or round suction cups, square-shaped covering one or more square and/or round suction cups, line-shaped covering various numbers of round and/or square suction cups.

In FIG. 3c shows that, if the matrix and the second array 250 at the second gripper 200 may be redivided into the second plurality of zones using the adapted zoning model, the second plurality of zones for the second gripper 200 may additionally be U-shaped covering a plurality of square and/or round suction cups.

Advantageously, the robot arm 10 having the plurality of grippers 100, 200, may allow gripping a broad portfolio of objects having various characteristics, such as various sizes and/or various shapes. By using the zoning model of the control module, switching the grippers 100, 200 may be more efficient und facilitated, as the zoning model may be adapted easily and thus may serve as a common or centralized model for all grippers without providing an individual control program for each of the plurality of grippers or each object.

Further, as shown in FIG. 1, the robot arm 10 may thus be used or implemented for the automation system 1 for palletizing or depalletizing a plurality of objects on the palletizing cell 20. Further, the automation system 1 may be provided, for example, in the vicinity of a conveyor belt, so that the robot arm 10 may be used to grip and transport various objects 21 from the palletizing cell 20 to the conveyor belt automatically by means of the control module having the matrix and the zoning model.

The control module, and specifically the zoning model, may be designed to be a configurable computer program or software. The zoning model may thus be moved from the robot arm 10 to a software application. For example, by adding the configurable matrix to the zoning model, new types of grippers may be set up in a configuration file efficiently, without requiring any complex coding before the integration.

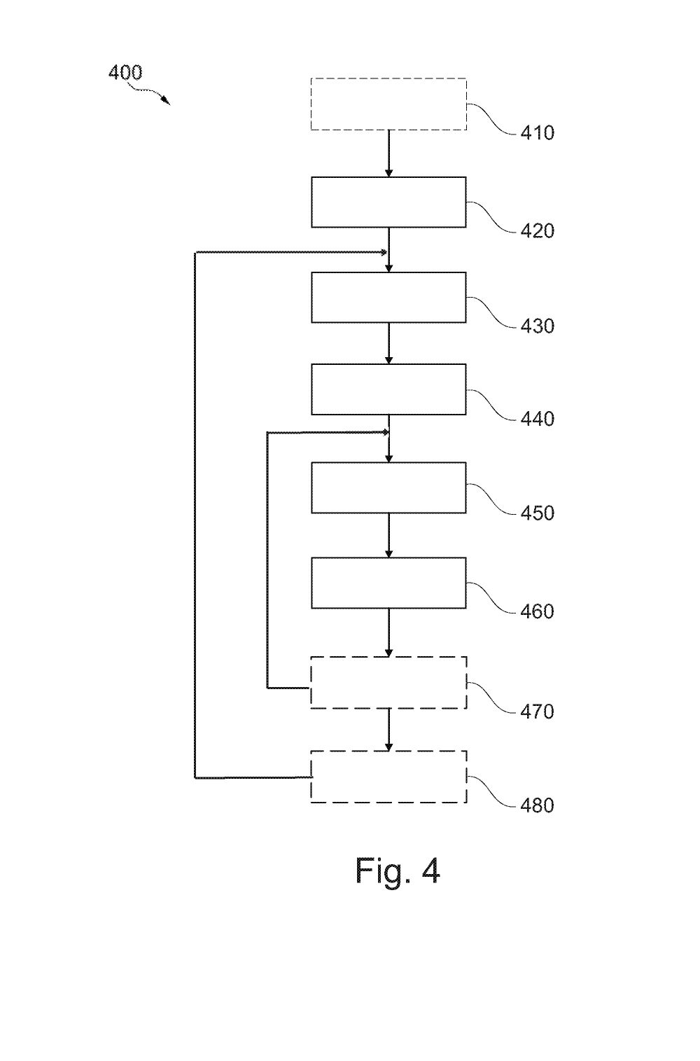

FIG. 4 shows a flow chat illustrating an embodiment of a method 400 for operating a robot arm 10 for an automation system 1 to grip a plurality of objects, for example, during palletizing or depalletizing a palletizing cell 20.

In step 420, a gripper 100 is mounted to the robot arm 10 for gripping an object 21. A plurality of suction elements 110 and 120 are arranged in an array 150. Each of the plurality of suction elements may be designed to be a suction cup, which may, for example, be a round, oval or rectangular suction cup.

In step 430, a control module is provided, which comprises a matrix for mapping the array 150 of the plurality of suction elements 110, 120 being arranged at the gripper 100. For example, the plurality of suction elements 110, 120 may comprise a first suction element 110 and a second suction element 120. The first suction element 110 may be arranged at a different x-coordinate and/or y-coordinate in the array 120 and the matrix than the second suction element 120. The control module may be arranged in a mobile terminal, a server or a cloud system, which is remote from the gripper 100 and configured to communicate with the gripper via a cable or wirelessly.

In step 440, the matrix and the array 150 of the plurality of suctions elements 110, 120 may be divided, by means of the zoning model, into a plurality of zones 115, 125. The zoning model may comprise a model-agnostic approach. For example, the plurality of zones may comprise a first zone 115, in which the first suction element 110 may be arranged, and a second zone 125, in which the second suction element is arranged. Each of the plurality of zones may be designed to be line-shaped, square-shaped, circle-shaped, L-shaped or U-shaped covering one or more suction elements having various sizes and/or various shapes.

The dividing of the matrix and the array 150 of the plurality of suction elements 110, 120 into the plurality of zones 115, 125 may be performed by means of the zoning model of the control module based on the at least one characteristic of the object 21 and/or a size/or a shape of each of plurality of the suction elements 110, 120 being arranged in the array 150.

Optionally, the method may comprise a step 410, in which the object 21 may be detected by means of an object detecting unit for analyzing at least one characteristic of the object 21. For example, the at least one characteristic of the object 21 may comprise a size, a shape, a center of gravity, a type of material and/or a way of packaging of the object. The step 410 of the detecting the object may be performed prior to the step 420 of the mounting the gripper and/or prior to the step 440 of the dividing the matrix and the array 150 of the plurality of suction elements 110, 120 into the plurality of zones 115, 125.

The step 440 of the dividing the matrix and the array 150 of the plurality of suction elements 110, 120 into the plurality of zones 115, 125 may be performed by means of the zoning model of the control module based on the at least one characteristic of the object 21 and/or a size/or a shape of each of plurality of the suction elements 110, 120 being arranged in the array 150.

In step 450, a group of zones out of the plurality of zones 115, 125 is determined or selected to be activated for gripping the object 21 by means of the zoning model of the control module. The selected group of zones may comprise one or more zones of the plurality of zones 115, 125. In particular, the step 450 of the determining 450 the group of zones to be activated out of the plurality of zones 115, 125 for gripping the object 21 may be performed by means of the zoning model of the control module based on the at least one characteristic of the object 21 and/or a size/or a shape of each of plurality of the suction elements 110, 120 being arranged in the array 150.

Alternatively or additionally, the step 410 of the detecting the second object by means of the object detecting unit may be repeatedly performed before the step 440 of dividing the matrix and the array into the plurality of zones and/or between the step 440 of dividing the matrix and the array into the plurality of zones and the step 450 of the determining the group of zones out of the plurality of zones 115, 125 to be activated. Alternatively, the at least one characteristic or property of the object may be determined by means of an MFC or WMS system instead of the object detecting unit, for example, in form of a vision system. For example, the object property may be acquired for each pick action to grip the object. In contrast, the steps of the mounting the gripper 420, the step of providing the control module with a matrix and a zoning model 430 and/or the step of dividing the matrix and the array into the plurality of zones 440 may be performed only once for the whole setup of the automation system.

Further, in step 460, a group of suction elements out of the plurality of suction elements 110, 120 are activated, which are arranged in the group of zones to be activated, to grip the object 21 by means of an actuating unit 500. In other words, after determining the selected group of zones in the matrix of the control module, the respective selected group of suction elements 110, 120 in the mapped array may be activated accordingly to grip the object 21.

Optionally, the method may further comprise an additional step 470, in which, by means of the zoning model of the control module, the matrix and the array 150 of the plurality of suctions elements 110, 120 may be redivided into a second plurality of zones for gripping a second object, optionally after detecting the second object by means of the object detecting unit. Hence, the step 410 of the detecting the second object by means of the object detecting unit may be repeatedly performed, once the selected group of suction elements 110, 120 are activated in step 460, the object 21 has already been gripped and released, and the gripper 100 may be ready for gripping the second object. Additionally, a second group of zones to be activated out of the second plurality of zones 115, 125 may be determined for gripping the second object by means of the control module, and a second group of suction elements out of the plurality of suction elements 110, 120, which may be arranged in the second group of zones, may be activated to grip the second object by means of the actuating unit 500.

Optionally, as an example, the method may further comprise an additional step 480, in which the gripper 100 may be replaced or switched with a second gripper 200, at which the plurality of suction elements 110 and 120 may be arranged in a second array 250, for gripping the second object, when the second object is detected and analyzed to be different than the object 21. Hence, the step 410 of the detecting the second object by means of the object detecting unit may be repeatedly performed, once the selected group of suction elements 110, 120 are activated in step 460, the object 21 has already been gripped and released, and the gripper 100 may be ready for gripping the second object. Further, the matrix of the control module may be adapted for mapping the second array 250 of the plurality of suction elements 110, 120, and the zoning model of the control module may be adapted for gripping the second object, so that the matrix and the second array may be divided into a second plurality of zones 115, 125, a second group of zones to be activated out of the second plurality of zones 115, 125 may be determined for gripping the second object, and the second group of suction elements being arranged in the second group of zones may be activated to grip the second object by means of the actuating unit 500.

For example, the robot arm may be an articulated robot arm, a six-axis robot arm, a cartesian robot or a collaborative robot arm, may be placed in the vicinity of a conveyor belt, so that the robot arm may be configured to move or transport the object, for example, from a palletizing cell onto the conveyor belt. Further, the type of the robot arm or the manipulator arm may not be limited to the types listed above.

The term the array may be understood broadly and may relate to a flexible 2D or 3D arrangement of the plurality of suction elements at the outer surface of the gripper. The array may be mapped or represented in the respective 2D matrix, so that the suction elements may be displayed on an interface in the matrix of the control module, for example, by means of an interface,

The gripper may be a vacuum gripper, which may be designed to be plated-shaped and comprise a gripper surface having a gripper surface area. The plurality of suction elements may thus be arranged on the gripper surface in an array comprising a plurality of columns along an x-axis and a plurality of rows along a y-axis. In other words, each of the plurality of suction elements may be arranged at a coordinate of the array or the matrix. Additionally, gaps or blanks may be provided between the columns and rows between the columns and rows and/or within one or more columns and rows. As such, in one or more columns or rows or at one or more coordinates in the respective matrix, one or more suction elements may not be provided or missing.

Each of the plurality of suction elements may be a suction cup and arranged at a different or individual x-coordinate and/or y-coordinate in the array.

The term mapping the array by the matrix may be understood broadly and may relate to providing the two-dimensional matrix to model and represent the real, three-dimensional array, in which the plurality of suction elements are arranged. The matrix may comprise a layout with the corresponding x-axis and y-axis, and the mapped suction elements in the matrix layout may represent, respectively, the corresponding suction elements being arranged in the array.

The control module may comprise an interface or display that may be configured to display the mapped matrix.

The term zoning model may be understood broadly and relate to a zoning logic or a zoning algorithm, by following which the mapped matrix and the corresponding array may be divided into the plurality of zones and, out of the plurality of zones, the group of divided zones may be determined or selected, so that the object may be gripped by the suction elements of the gripper in a most efficient and reliable manner.

The actuating unit may be arranged between the gripper and the freestanding end of the robot arm, when not being equipped with the gripper. The actuating unit may be configured to activate and/or deactivated the various zones for the object, once the plurality of zones is divided and the selected group of zones to be activated is determined for the specific object based on the zoning model.

By following the steps, the method may allow a generic gripper to grip the object, which may be within a predefined size range or shape range, for example, based on the gripper surface area and/or the density and/or the distribution of the suction elements on the gripper surface.

Further, the method using the matrix and the zoning model may allow configuring and zoning the gripper having the plurality of suction elements in an easy and programming-free way.

According to an embodiment, the group of zones to be activated may comprise one or more zones of the plurality of zones. The group of zones to be activated may be determined or selected to be activated, so that the object may be gripped in an efficient and reliable way.

Alternatively, or additionally, the control module may be configured to determine and select a group of zones to be deactivated. Accordingly, the actuating unit may be configured to deactivate the suction elements being arranged within the selected group of zones to be deactivated when gripping the object by the vacuum gripper.

According to another embodiment, the method may further comprise the step of detecting the object by means of an object detecting unit for analyzing at least one characteristic of the object. The at least one characteristic of the object may comprise a size, a shape, a center of gravity, a type of material and/or a way of packaging of the object.

The object detection unit may be integrated in the robot arm or provided separately to detect or monitor the object. It may be provided that the control module may comprise an internal library containing, for example, the matrix layout of the gripper and/or versatile prestored characteristics of the object. Once the object is detected by the object detection unit, for example a camera, the control module may be able to divide the matrix into the plurality of zones in an optimized manner based on the invoked matrix layout of the gripper and/or one or more characteristics of the detected object.

Alternatively, or additionally, the object detecting unit may be configured to evaluate or analyze the characteristics of the object while detecting the object. The characteristics or the properties may not be limited to those listed above, but may also be used to determine the gripper type, the layout or design of the array of the suction elements at the gripper, the respective matrix of the control module, and the like.

According to another embodiment, the zoning model of the control module may comprise a model-agnostic approach. By means of the model-agnostic approach, the gripper matrixing may be provided without being limited to or designed for a specific gripper, but in a generic use for a flexible gripper design or layout.

Compared to the conventional zoning logic, by using the model-agnostic approach of the zoning model, it may not be a prerequisite any more to develop or modify a different evaluation framework for each model type of the gripper and for each type of object. Moreover, the model-agnostic approach of the zoning model may allow comparing many models using the same matrix. As such, the zoning model may serve as a generic model for the robot arm having various grippers, matrix layouts and/or objects.

The model-agnostic approach of the zoning model may allow a more flexible evaluation, by considering the object and/or the matrix and array of the plurality of suction elements for dividing or zoning the layout and/or determining the group of zones to be activated and/or deactivated to grip the object.

According to another embodiment, the step of dividing the matrix and the array of the plurality of suction elements into the plurality of zones may be performed in a mobile terminal, a server or a cloud server that is remote from the gripper.

In particular, the dividing or zoning the matrix and the array may be performed remotely from the gripper by the control module being arranged separately in the server or cloud server. This may allow a centralized control over the dividing the matrix and/or the determining the group of zones to be activated.

According to another embodiment, the step of dividing the matrix and the array of the plurality of suction elements into the plurality of zones may be performed by means of the zoning model of the control module based on the at least one characteristic of the object and/or a size/or a shape of each of the plurality of suction elements being arranged in the array.

In addition, the step of dividing the matrix and the array may be performed by the density and/or the distribution of the suction elements being arranged in the array.

Alternatively, or additionally, the step of detecting the object by means of the object detecting unit may be performed or repeated prior to the dividing or zoning the matrix and the array.

Alternatively, without the step of detecting the object by means of the object detecting unit, the object properties or characteristics may be determined or received from an MFC (material flow control) system, a WMS system (warehouse management system) and/or a database.

According to another embodiment, the step of determining the group of zones to be activated out of the plurality of zones for gripping the object may be performed by means of the zoning model of the control module based on the at least one characteristic of the object and/or a size/or a shape of each of the plurality of suction elements being arranged in the array.

Alternatively, or additionally, the step of detecting the object by means of the object detecting unit may be performed or repeated prior to the determining the group of zones to be activated out of the plurality of zones for gripping the object.

According to another embodiment, the method may further comprise the following steps: redividing, by means of the zoning model of the control module, the matrix and the array of the plurality of suctions elements into a second plurality of zones for gripping a second object; determining a second group of zones to be activated out of the second plurality of zones for gripping the second object by means of the control module; and activating a second group of suction elements out of the plurality of suction elements, which may be arranged in the second group of zones to be activated, to grip the second object by means of the actuating unit.

For example, the step of redividing the matrix and the array into the second plurality of zones that may be different from the first plurality of zones for gripping a second object comprising at least one different characteristic than the first object may be performed after detecting the second object by means of the object detecting unit or after the second object may be determined by the MFC or WMS system and/or the data base.

Advantageously, by following the above described method, the generic robotic gripper may be able to handle a broad distribution of objects and various types of applications, since the same matrix or matrix layout may be repeatedly divided into different pluralities of zones for various objects, such as the object and the second object, and different groups of zones to be activated may be determined, respectively, for each individual object. The different groups of zones to be activated may be smaller or bigger than the gripper surface area. By using the zoning model of the control module, the method may serve as a generic and universal method for the robot arm with an increased flexibility and an improved cost-efficiency without substantially adding extra complexity to the automation system.

According to another embodiment, the method may further comprise the following steps: replacing the gripper with a second gripper, at which the plurality of suction elements may be arrangeable in a second array, for gripping the second object, when the second object is detected and analyzed to be different than the object; adapting the matrix of the control module for mapping the second array of the plurality of suction elements; and adapting the zoning model of the control module for gripping the second object.

The robot arm may be designed for a set of grippers or a plurality of grippers comprising the gripper and the second gripper. Each of the plurality of grippers may be mounted to the robot arm for gripping a specific group of objects. It may be provided that the gripper may need to be switched by the second gripper, once the second object may be detected by the object detecting unit.

Advantageously, the method using the matrix and the zoning model in the control module may facilitate the configuration of a complex and divers gripper layout. Moreover, the method using the matrix layout for representing the array of the gripper may further enable the zoning and activating the suction elements to be independent from the type of the gripper.

Further, the method using the matrix and the zoning model may allow configuring and zoning the gripper having the plurality of suction elements in an easy and programming-free way. Also, the method may allow an easy and programming free transition between different grippers. Therefore, the method with multiple zoning of a gripper and various grippers in combination may further enlarge the use scope of the generic robot arm for the broader distribution of objects and more various types of applications, resulting in a further increased flexibility and a further improved cost-efficiency without substantially adding extra complexity to the automation system.

According to a second aspect, a robot arm for an automation system is provided. The robot arm comprises a gripper, which comprises a plurality of suction elements and is configured to grip an object, a control module, which comprises a matrix and a zoning model, and an actuating unit.

The plurality of suction elements is arrangeable in an array at the gripper. The matrix of the control module is configured to map the array of the plurality of suction elements.

The term the array may be understood broadly and may relate to a flexible 2D or 3D arrangement of the plurality of suction elements at the outer surface of the gripper. The array may be mapped or represented in the respective 2D matrix, so that the suction elements may be displayed on an interface in the matrix of the control module, for example, by mean of an interface of the control module, Alternative or in addition to that each of the plurality of suction elements may be arranged at a coordinate of the array or the matrix, gaps or blanks may be provided between the columns and rows and/or within one or more columns and rows. For example, in one or more columns or rows or at one or more coordinates in the respective matrix, one or more suction elements may not be arranged or missing.

The control module is configured to divide, by means of the zoning model, the matrix and the array of the plurality of suction elements into a plurality of zones and to determine a group of zones to be activated out of the plurality of zones for gripping the object. Further, the actuating unit is configured to activate a group of suction elements out of the plurality of suction elements, which are arranged in the group of zones to be activated, to grip the object.

The matrix or the matrix layout may be divided, so that the smallest zone may comprise at least one single suction element, while the largest possible zone may comprise a maximum of all suction elements being arranged in the array at the gripper.

Advantageously, the dividing the matrix of the plurality of suction elements and the array may allow a flexible configuration of the zones without specific limitation.

According to an embodiment, each of the plurality of suction elements may be designed to be a suction cup. According to another embodiment, the suction cup may be a round suction cup, an oval suction cup or a rectangular suction cup. According to another embodiment, the suction cup may be a flat suction cup or a bellow suction cup. The plurality of suction elements may comprise various types of suctions cups having different sizes and/or different shapes. It may be advantageous that, by using the matrix and the array of the control module, different types and sizes of suction cups may be used on the same gripper. Alternatively, it may be provided that suctions cups having the same predefined size and shape may be arranged in the array on the gripper surface of the gripper.

According to another embodiment, the control module may be arranged in the robot arm. Alternatively, the control module may be arranged in a mobile terminal, a server or a cloud system, which may be remote from the gripper.

According to another embodiment, the robot arm may further comprise an object detecting unit, which may be configured to detect the object for analyzing at least one characteristic of the object. The at least one characteristic of the object may comprise a size, a shape, a center of gravity, a type of material and/or a way of packaging of the object.

Alternatively, or additionally, the at least one characteristic of the object may be determined or received from a MFC system, a WMS system and/or a database, without using the object detecting unit. According to another embodiment, the plurality of suction elements may comprise a first suction element and a second suction element. The first suction element may comprise a different x-coordinate and/or y-coordinate in the array and the matrix than the second suction element.

According to another embodiment, the plurality of zones may comprise a first zone, in which the first suction element may be arranged, and a second zone, in which the second suction element may be arranged. The control module may be configured to determine, by means of the zoning module, the group of zones to be activated out of the plurality of zones comprising the first zone and/or the second zone to be activated, based on the at least one characteristic of the object and/or a size/or a shape of each of the plurality of suction elements being arranged in the array.

According to another embodiment, each of the plurality of zones to be activated may be line-shaped, square-shaped, circle-shaped, L-shaped or U-shaped.

Advantageously, the matrix may allow to divide and determine different shapes of zones. The differently shaped zones may be configured to cover one or more suction elements. For example, the L-shaped zones may be configured to cover, respectively, a single or more suction elements and thus comprise various lengths of zones.

According to another embodiment, the control module may be configured to redivide, by means of the zoning model, the matrix and the array of the plurality of suction elements into a second plurality of zones for gripping a second object, when the second object is detected by means of the object detecting unit.

Accordingly, the control module may be configured to determine a second group of zones to be activated out of the second plurality of zones for gripping the second object. And the actuating unit may be configured to activate a second group of suction elements out of the plurality of suction elements, which are arranged in the group of zones to be activated, to grip the second object.

According to another embodiment, the robot arm may further comprise a second gripper, which may be configured to replace the gripper for gripping the second object, when the second object may be detected by means of the object detecting unit. The plurality of suction elements may be arranged in a second array at the second gripper.

The robot arm may comprise a plurality of grippers, each of which may be adapted for one or more of the plurality of objects, which for example may be provided in a palletizing cell. The plurality of grippers may comprise the gripper and the second gripper.

In order to grip the second object by the second gripper, the control module may be configured to adapt the matrix for mapping the second array of the plurality of suction elements and to adapt the zoning model for gripping the second object.

In this way, the robot arm may be configured to allow an easy and programming free transition between different grippers using the method of the present disclosure.

According to another aspect, the use of a robot arm for an automation system is provided for palletizing or depalletizing a plurality of objects in a palletizing cell. Additionally, the use of the robot arm may also be provided for further automation applications, for example, for object picking or packing, logistics, installation and/or system management,

By using the gripper having the generic zoning model of the control module, the generic and universal robot arm may be implemented in the automation system to allow efficiently handling or gripping different sizes of the objects of the palletizing cell, thereby allowing automatically depalletizing the objects and, for example, transporting the objects from the palletizing cell onto a conveyor belt of an assembly line.

According to another aspect, there is provided a computer program that comprises machine-readable instructions that, when executed by one or more computers and/or compute instances, cause the one or more computers and/or compute instances to perform a method for operating a robot arm for an automation system.

According to another aspect, there is provided a non-transitory machine-readable data carrier and/or a download product with the computer program. A download product is an instance of the computer program that may be sold and downloaded online for immediate fulfilment in lieu of physically shipping a machine-readable data carrier.

According to another aspect, there are provided one or more computers and/or compute instances with the computer program comprising machine-readable instructions that, when executed by one or more computers and/or compute instances, cause the one or more computers and/or compute instances to perform a method for operating a robot arm for an automation system, and/or with the machine-readable data carrier and/or download product with the computer program.

The method may be at least partly computer-implemented, and may be implemented in software or in hardware, or in software and hardware. Further, the method may be carried out by computer program instructions running on means that provide data processing functions. The data processing means may be a suitable computing means, such as an electronic control module etc., which may also be a distributed computer system. The data processing means or the computer, respectively, may comprise one or more of a processor, a memory, a data interface, or the like.

The method of the present disclosure, in particular the zoning model or the zoning logic that may determine which suction elements or zones of suctions elements need to be activated, will be provided or moved to a computer program application to an application controller above the robot arm itself. The software layer may thus contain a generic method with the proprietary algorithm to optimize the activation of the suction elements and the zones. Further, in order to enable a specific physical gripper and its layout, a mathematical matrix representation is made in the software layer, for example in an interface. Within the respective array of suction elements, different zones with various zone sizes and zone shapes in combination may be determined. As a result, the virtual gripper matrix and the zones that are derived from the matrix may be configured in a configuration file which is located in the software application and may be reconfigured using the integrated zoning model. Further, by deploying the software with the generic zoning model, the applications may be less prone to errors since there may be no custom programming required within the robot itself.

Advantageously, the method used by the software application may be generic and configuration-based. Changing or switching a gripper on the robot arm may be nothing more than changing the configuration file of the zoning model of the specific gripper, and no additional and individual programming may be required. For example, by deploying a standard product for a palletizing or depalletizing cell, choosing and implementing a specific gripper for the application may advantageously not involve any custom work but only configuration or reconfiguration, which may result in a shorter start-up time.

It should be noted that the above examples may be combined with each other irrespective of the aspect involved. Accordingly, the method may be combined with structural features and, likewise, the apparatus and the system may be combined with features described above with regard to the method.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

1 automation system

10 robot arm

20 palletizing cell

21 object

100 gripper

110 first suction element

115 first zone

120 second suction element

125 second zone

150 array

200 second gripper

250 second array

500 actuating unit

400 method for operating a robot arm

410 step of detecting an object

420 step of mounting a gripper

430 step of providing a control module with a matrix and a zoning model

440 step of dividing a matrix and an array into a plurality of zones

450 step of determining a group of zones to be activated out of the plurality of zones

460 step of activating a group of suction elements

470 step of dividing the matrix and the array into a second plurality of zones

480 step of replacing the gripper with the second gripper

What is claimed is:

1. A method for operating a robot arm for an automation system, comprising:
mounting a gripper having a plurality of suction elements arrangeable in an array for gripping an object;
providing a control module comprising a matrix for mapping the array of the plurality of suction elements being arranged at the gripper and a zoning model;
dividing, using the zoning model, the matrix and the array of the plurality of suctions elements into a plurality of zones;
determining a group of zones to be activated out of the plurality of zones for gripping the object using the zoning model of the control module; and
activating a group of suction elements out of the plurality of suction elements, which are arranged in the group of zones to be activated, to grip the object using an actuating unit.

2. The method according to claim 1, wherein the group of zones to be activated comprises one or more zones of the plurality of zones.

3. The method according to claim 1, further comprising detecting the object using an object detecting unit for analyzing at least one characteristic of the object; wherein the at least one characteristic of the object comprises a size, a shape, a center of gravity, a type of material and/or a way of packaging of the object.

4. The method according to claim 3, wherein the zoning model of the control module comprises a model-agnostic approach.

5. The method according to claim 1, wherein dividing the matrix and the array of the plurality of suction elements into the plurality of zones is performed in a mobile terminal, a server, or a cloud server, that is remote from the gripper.

6. The method according to claim 5, wherein dividing the matrix and the array of the plurality of suction elements into the plurality of zones is performed using the zoning model of the control module based on the at least one characteristic of the object and/or a size/or a shape of each of the plurality of suction elements being arranged in the array.

7. The method according to claim 5, wherein determining the group of zones out of the plurality of zones to be activated for gripping the object is performed using the zoning model of the control module based on the at least one characteristic of the object and/or a size/or a shape of each of the plurality of suction elements being arranged in the array.

8. The method according to claim 1, further comprising:
redividing, using the zoning model of the control module, the matrix and the array of the plurality of suctions elements into a second plurality of zones for gripping a second object;
determining a second group of zones to be activated out of the second plurality of zones for gripping the second object using the control module; and
activating a second group of suction elements out of the plurality of suction elements, which are arranged in the second group of zones to be activated, to grip the second object using the actuating unit.

9. The method according to claim 8, further comprising:
replacing the gripper with a second gripper, at which the plurality of suction elements are arrangeable in a second array, for gripping the second object, when the second object is detected and analyzed to be different than the object;
adapting the matrix of the control module for mapping the second array of the plurality of suction elements; and
adapting the zoning model of the control module for gripping the second object.

10. A robot arm for an automation system, comprising:
a gripper comprising a plurality of suction elements configured to grip an object;
a control module comprising a matrix and a zoning model, and
an actuating unit;
wherein the plurality of suction elements is arrangeable in an array at the gripper;
wherein the matrix of the control module is configured to map the array of the plurality of suction elements;
wherein the control module is configured to divide, using the zoning model, the matrix and the array of the plurality of suction elements into a plurality of zones and to determine a group of zones to be activated out of the plurality of zones for gripping the object; and
wherein the actuating unit is configured to activate a group of suction elements out of the plurality of suction elements, which are arranged in the group of zones to be activated, to grip the object.

11. The robot arm according to claim 10, wherein each of the plurality of suction elements is a suction cup.

12. The robot arm according to claim 11, wherein the suction cup is a round suction cup, an oval suction cup or a rectangular suction cup.

13. The robot arm according to claim 11, wherein the suction cup is a flat suction cup or a bellow suction cup.

14. The robot arm according to claim 13. wherein the control module is arranged in one of the robot arm, a mobile terminal, a server, or a cloud system.

15. The robot arm according to claim 10, further comprising an object detecting unit configured to detect the object for analyzing at least one characteristic of the object; wherein the at least one characteristic of the object comprises a size, a shape and/or a center of gravity of the object.

16. The robot arm according to claim 10, wherein the plurality of suction elements comprises a first suction element and a second suction element; and wherein the first suction element comprises a different x-coordinate and/or y-coordinate in the array and the matrix than the second suction element.

17. The robot arm according to claim 16, wherein the plurality of zones comprises a first zone, in which the first suction element is arranged, and a second zone, in which the second suction element is arranged; wherein the control module is configured to determine, using the zoning module, the group of zones to be activated out of the plurality of zones comprising the first zone and/or the second zone, based on the at least one characteristic of the object and/or a size/or a shape of each of the plurality of suction elements being arranged in the array.

18. The robot arm according to claim 17, wherein each of the plurality of zones is line-shaped, square-shaped, circle-shaped, L-shaped or U-shaped.

19. The robot arm according to claim 18, wherein the control module is configured to redivide, using the zoning model, the matrix and the array of the plurality of suction elements into a second plurality of zones for gripping a second object, when the second object is detected by means of the object detecting unit; wherein the control module is configured to determine a second group of zones to be activated out of the plurality of zones for gripping the second object; and wherein the actuating unit is configured to activate a second group of suction elements out of the plurality of suction elements, which are arranged in the group of zones to be activated, to grip the second object.

20. The robot arm according to claim 19, further comprising a second gripper; wherein the plurality of suction elements is arrangeable in a second array at the second gripper; wherein the second gripper is configured to replace the gripper for gripping the second object, when the second object is detected using the object detecting unit; wherein the control module is configured to adapt the matrix for mapping the second array of the plurality of suction elements and to adapt the zoning model for gripping the second object.
